(19) United States
(12) Patent Application Publication
(10) Pub. No.: US 2004/0109648 A1
(43) Pub. Date: Jun. 10, 2004

(54) Optical transceiver module and method of arranging its optical path

(76) Inventors: Yu-Hong Shiu, Nantou (TW); Yu-Nien Lin, Taipei (TW)

Correspondence Address: BIRCH STEWART KOLASCH & BIRCH, PO BOX 747, FALLS CHURCH, VA, 22040-0747, US

(21) Appl. No.: 10/419,166

(22) Filed: Apr. 21, 2003

(30) Foreign Application Priority Data
Dec. 10, 2002 (TW) 091135721

(51) Int. Cl. G02B 6/43

(52) U.S. Cl. 385/89; 385/92

(57) ABSTRACT

We provide an optical transceiver module and the method of arranging its optical path. The invention is used to send optical signals to an optic fiber and receives optical signals emitted from the optic fiber. The optical transceiver module contains an optical transmitting device and a circuit board. One side of the optical transmitting device is equipped with an optic fiber connecting terminal to connect with an optic fiber. A filter is used to deflect optical signals emitted from the optic fiber. After the optical signals enter the input terminal, they are converted by an opto-electrical conversion unit into electrical signals that are then sent to the circuit board. Likewise, an output terminal receives electrical signals generated by the circuit board. The opto-electrical conversion unit converts the electrical signals into optical signals, which directly penetrate through the filter to send the signals to the optic fiber. The invention can simultaneously receive and transmit optical signals to greatly enhance the convenience of the products. The fabrication cost can be lowered too.

### BACKGROUND OF THE INVENTION

1. Field of Invention

The present invention relates to an optical transceiver module and the method of arranging its optical path, and more particularly, to an optical transceiver module that is capable of integrating input and output signals transmitted through the optical transceiver module in one optical path.

2. Related Art

The tremendous progress in the opto-electrical industry has greatly facilitated the convenience of human life. Examples such as optic fiber network applications and recreational home electronic products development are all attributed to efforts in opto-electrical communications researches. In particular, the conversion and transmission of optical signals and electrical signals play important roles. Installing an optical transceiver module in an electronic device enables the electronic device to receive or emit optical signals through an optic fiber. With reference to FIG. 1, the optical transceiver module basically has a housing 11, a base 12, a receiver 13, an emitter 14, and two circuit boards 16, 17. The base 12 is used to support the circuit boards 16, 17, and the housing 11 is used to cover the base 12. The two circuit boards 16, 17 respectively having functions of emitting and receiving optical signals are connected to the emitter 14 and the receiver 13, respectively. Finally, the circuit boards 16, 17 are connected to an electronic device via pins 15.

From the above description, one sees that the conventional design uses the receiver 13 and the emitter 14 to receive and emit signals, respectively. The circuit boards are divided into two blocks to avoid crosstalks, promoting the transmission quality. However, the receiving and emitting actions are separately processed. Therefore, the require space is big and the cost is higher. Moreover, the two circuit boards have to be placed very close to each other in order to minimize the volume. This does not only make the assembly difficult, but also limit the testing and debugging of products.

### SUMMARY OF THE INVENTION

To solve the above problems, an optical transceiver module and related methods of arranging optical paths thereof are disclosed. It has the advantages of minimizing the module size and integrating the receiving and emitting terminals.

According to the present invention, the optical transceiver module has an optical transmitting device and a circuit board. The optical transmitting device includes an optic fiber connecting terminal that integrates the conventional receiving and emitting terminals for connecting an external optic fiber. A filter is used to deflect a first optical signal input from the optic fiber by an angle to enter a first opto-electrical conversion unit, converting the first optical signal into a first electrical signal. The first electrical signal is then transmitted to the circuit board via the output terminal. On the other hand, when sending signals, the input terminal receives a second electrical signal sent from the circuit board. A second opto-electrical conversion unit converts the second electrical signal into a second optical signal, which directly penetrates through the filter and reaches the optic fiber.

It should be mentioned that the circuit board has pins for connecting with an electronic device. In order to protect the electronic devices on the circuit board and the adjacent optical transmitting device, a housing is used to cover them and protect them from damages caused by dusts. Only the optic fiber connecting terminal and the pins are exposed to the exterior. For enhancing the intensity of optical signals, the first opto-electrical conversion unit and the second opto-electrical conversion unit are installed with a lens, respectively, so that the optical signals can be converged into the optic fiber or the first opto-electrical conversion unit.

The invention uses an optic fiber connecting terminal to connect with an external optic fiber. The filter installed inside the optical transmitting device deflects the optical signals from the optic fiber into one opto-electrical conversion unit. The optical signal is converted into an electrical signal, which in turn is transmitted to the circuit board. Likewise, the other opto-electrical conversion unit converts the electrical signal from the circuit board into an optical signal, which is transmitted to the external optic fiber via the filter. Therefore, the invention can selectively input and output optical signals. Furthermore, convergent lenses are employed to enhance the intensity of the optical signals. The transmission quality can thus be greatly promoted. The simple assembly method and the integration of optical signal input and output further lower the production cost.

### BRIEF DESCRIPTION OF THE DRAWINGS

The invention will become more fully understood from the detailed description given hereinbelow illustration only, and thus are not limitative of the present invention, and wherein:

FIG. 1 is a three-dimensional view of a conventional optical transmission module;

FIG. 2 is a three-dimensional view of an optical transceiver module according to the present invention;

FIG. 3 is a side cross-sectional view of an optical transmitting device depicted in FIG. 2 according to the first preferred embodiment of the present invention;

FIG. 4 is a schematic view of operations of the optical transmitting device depicted in FIG. 2 according to the first preferred embodiment of the present invention;

FIG. 5 is a schematic flowchart for the disclosed optical transceiver module according to the first preferred embodiment of the present invention;

FIG. 6 is a schematic view of operations of the optical transmitting device according to the second preferred embodiment of the present invention; and

FIG. 7 is a schematic flowchart for the disclosed optical transceiver module according to the second preferred embodiment of the present invention.

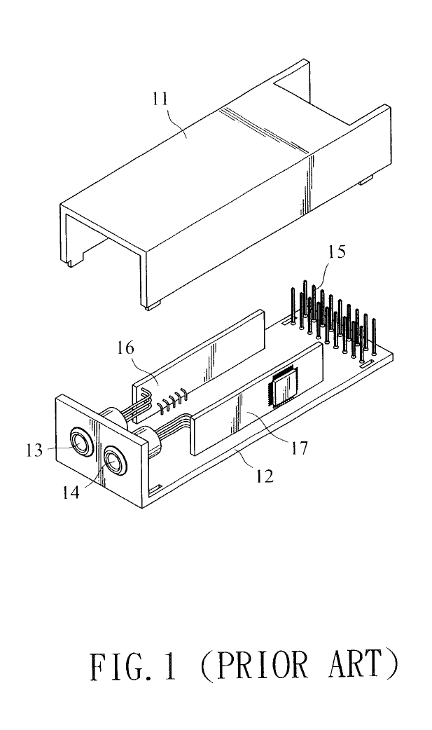

### DETAILED DESCRIPTION OF THE INVENTION

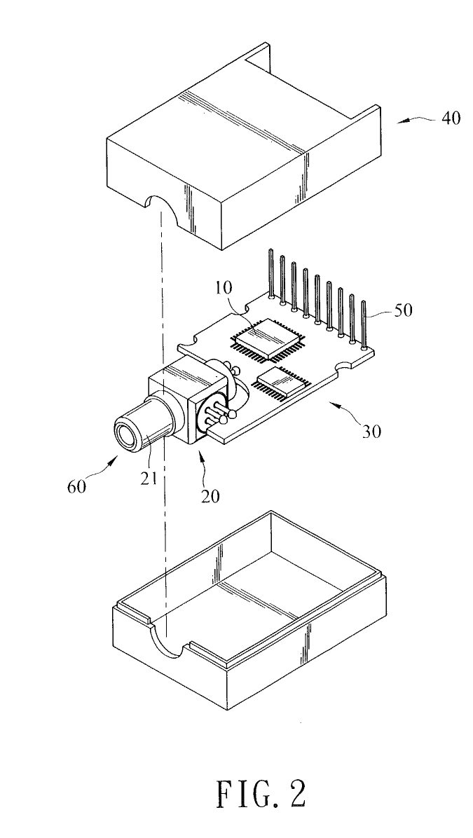

In accord with the invention, the optical transceiver module includes an optical transmitting device 20 and a circuit board 30. With reference to FIG. 2, several electronic components are installed on one side of the circuit board 30 for processing electrical signals input to and output from the optical transmitting device 20. The circuit board 30 is connected to an electronic device via pins 50. To protect the electronic components 10 on the circuit board 30 and the adjacent optical transmitting device 20, a housing 40 is used to cover them and protect them from damages caused by dusts. Only an optic fiber connecting terminal 21 and the pins 50 are exposed to the exterior.

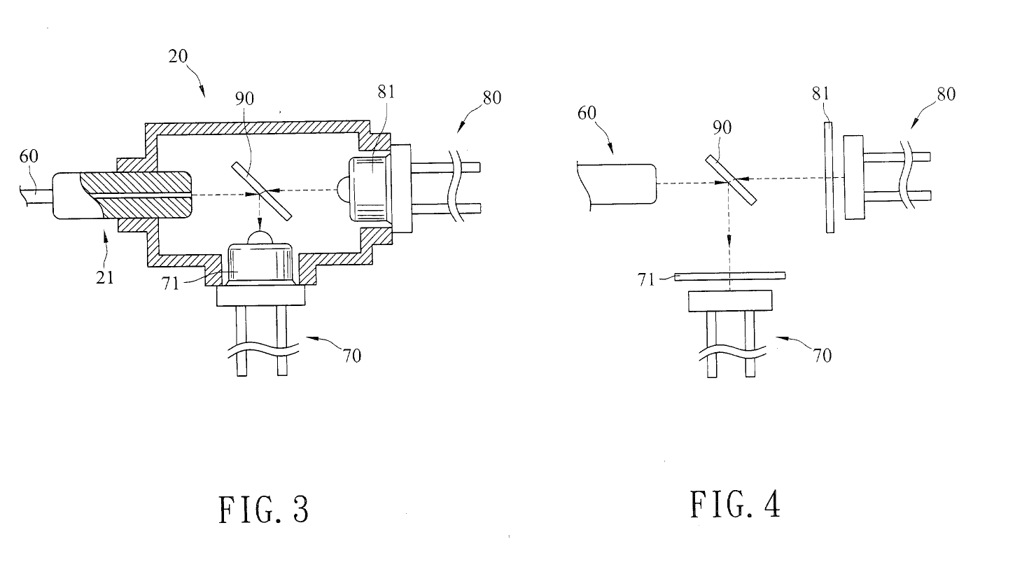

As shown in FIG. 3, one side of the optical transmitting device 20 has the optic fiber connecting terminal 21 for connecting with an external optic fiber 60. On the other side opposite to the optic fiber connecting terminal 21 of the optical transmitting device 20 has an input terminal 80, which is connected to the circuit board 30. The optical transmitting device 20 further has an output terminal 70, which is also connected to the circuit board 30, installed adjacent to the optical fiber connecting terminal 21. It should be noted that the output terminal 70 and the input terminal 80 installed on neighbor sides of the optical transmitting device 20 have a first opto-electrical conversion unit 71 and a second opto-electrical conversion unit 81, respectively. According to arrangement of optical paths of the invention, a filter 90 is installed inside the optical transmitting device 20 at an angle with respect to the optical path of the optical signal from the optic fiber 60. Therefore, the filter 90 deflects the optical signals transmitted from the optic fiber 60 by a predetermined angle (to be described in detail later).

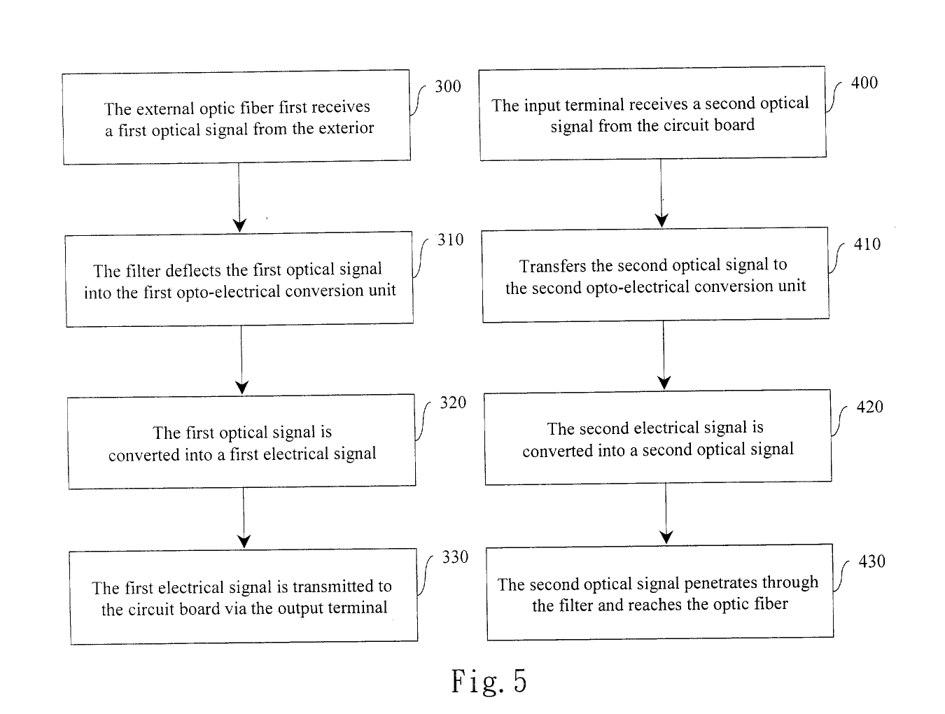

The relative relations of the devices in the invention and the assembly can be clearly seen from the above description. FIGS. 4 and 5 are used to describe in detail the operation and the method of arranging the optical path. When receiving optical signals, the external optic fiber 60 first receives a first optical signal from the exterior (step 300). The filter 90 deflects the first optical signal into the first opto-electrical conversion unit 71 (step 310), and the first optical signal is then converted into a first electrical signal (step 320). The first electrical signal is then transmitted to the circuit board 30 via the output terminal 70 (step 330). When transmitting electrical signals, the input terminal 80 receives a second optical signal from the circuit board 30 (step 400) and transfers it to the second opto-electrical conversion unit 81 (step 410), where the second electrical signal is converted into a second optical signal (step 420). The second optical signal penetrates through the filter 90 and reaches the optic fiber 60 (step 430). In other words, the filter 90 deflects the first optical signal transmitted from the optic fiber 60 to the output terminal 70, while transmits the second optical signal from the input terminal 80 to the optic fiber 60. Therefore, the configuration is different from the prior art. Only one optic fiber connecting terminal 21 and one optic fiber 60 are required to selectively perform input and output actions of the optical signals.

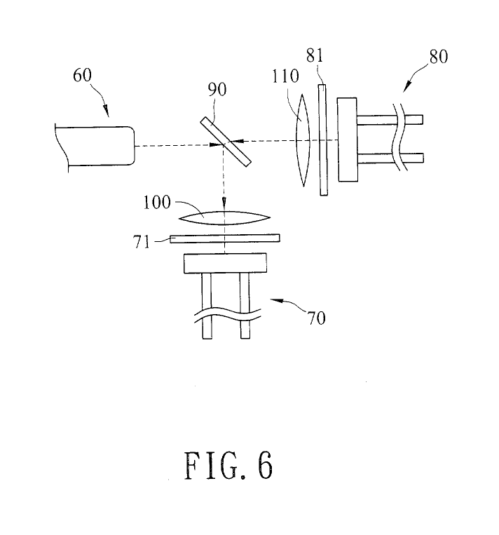

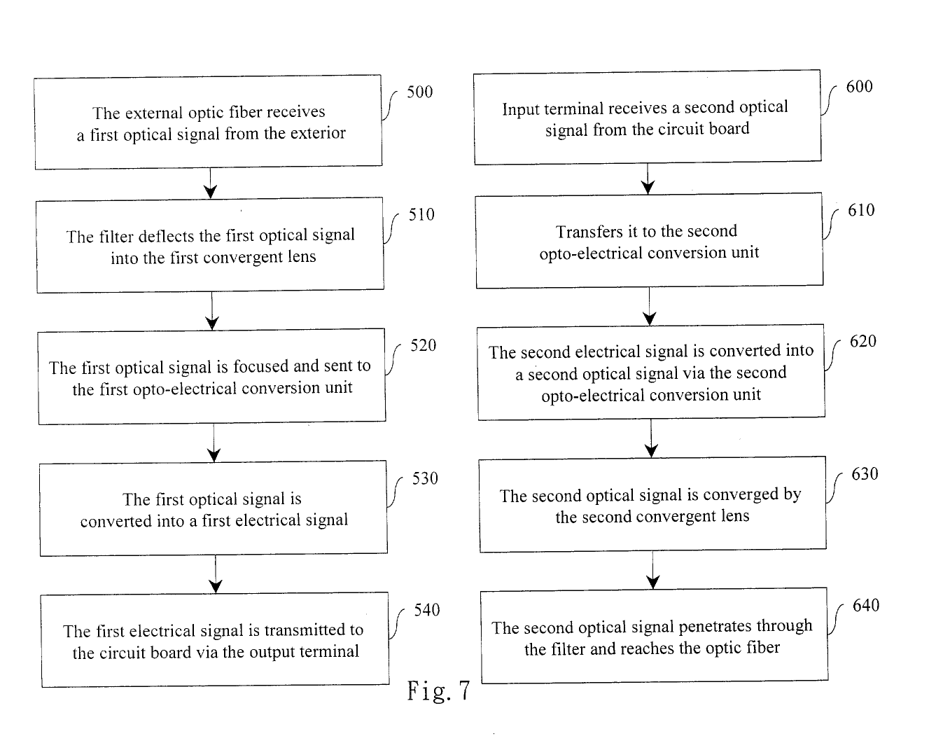

An optical transmitting device of the second preferred embodiment of the present invention is shown in FIGS. 6 and 7. The first opto-electrical conversion unit 71 and the second opto-electrical conversion unit 81 are installed with a first convergent lens 100 and a second convergent lens 110 to enhance the intensity of optical signals. It should be mentioned that the convergent lenses 100, 110 have a gradient index of refraction. Such lenses are mostly used in probing the interior of tiny or thin and long things for diagnosis. They are used for light focusing and collimation in signal transmissions. For example, they have been used in optical telecommunications, optical isolators, collimators, endoscopic lens systems, and DWDM devices.

In this paragraph, we describe in detail the operation and optical path arrangement in the second embodiment. When receiving optical signals, the external optic fiber 60 first receives a first optical signal from the exterior (step 500). The filter 90 deflects the first optical signal into the first convergent lens 100 (step 5 10). The first optical signal is thus focused and sent to the first opto-electrical conversion unit 71 (step 520), and the first optical signal is then converted into a first electrical signal (step 530). The first electrical signal is then transmitted to the circuit board 30 via the output terminal 70 (step 540). When transmitting electrical signals, the input terminal 80 receives a second optical signal from the circuit board 30 (step 600) and transfers it to the second opto-electrical conversion unit 81 (step 610), where the second electrical signal is converted into a second optical signal (step 620). The second optical signal is converged by the second convergent lens 110 (step 630) and penetrates through the filter 90 and reaches the optic fiber 60 (step 640). In other words, the first optical signal transmitted from the optic fiber 60 is deflected by the filter 90 and converged by the first convergent lens 100 to the output terminal 70, while the second optical signal is transmitted via the input terminal 80 and the second convergent lens 1 10 to the optic fiber 60. Therefore, the configuration is different from the prior art. Only one optic fiber connecting terminal 21 and one optic fiber 60 are required to selectively perform input and output actions of the optical signals. Moreover, convergent lenses are employed to enhance the intensity of the optical signals, thereby promoting the quality of optical signal transmissions.

Certain variations would be apparent to those skilled in the art, which variations are considered within the spirit and scope of the claimed invention.

What is claimed is:

1. An optical transceiver module which transmits signals through a single optic fiber, comprising:
an optical transmitting device including an optic fiber connecting terminal on one end for coupling with the optic fiber, an output terminal, and an input terminal; and
wherein the output terminal is adjacent to the optic fiber connecting terminal and the input terminal is opposite to the connecting terminal, the input terminal and the output terminal both have an opto-electrical conversion unit for converting the optical/electrical signal into an electrical/optical signal, the optical signal transmitted from the optic fiber enters the input terminal and is converted by the opto-electrical conversion unit into the electrical signal, the electrical signal entered via the input terminal is converted by the opto-electrical conversion into the optical signal which is then sent to the optic fiber, and the optical path of the optical signal is installed with a filter;
a circuit board, which is connected to the output terminal and the input terminal for receiving the electrical signal from the output terminal and transmitting the electrical signal to the input terminal;
wherein the filter is installed inside the optical transmitting device at an angle with respect to the optical axis of the optic fiber, so that the optical signal transmitted from the optic fiber is deflected by the filter into the output terminal while the optical signal from the input terminal penetrates the filter to enter the optic fiber.

2. The optical transceiver module of claim 1, wherein the circuit board comprises a plurality of electronic components.

3. The optical transceiver module of claim 1, wherein the circuit board has a plurality of pins.

4. The optical transceiver module of claim 3 further comprising a housing for covering the optical transmitting device and the circuit board, only exposing the optic fiber connecting terminal and the pins to the exterior.

5. The optical transceiver module of claim 1, wherein a convergent lens is installed at the input terminal and the output terminal of the optical transmitting device for converging the optical signal into the optical fiber and the opto-electrical conversion unit, respectively.

6. An optical transceiver module connected to an optic fiber for transmitting/receiving an optical signal to/from the optic fiber, comprising:
an optical transmitting device including a connecting terminal on one end for coupling with the optic fiber, an output terminal, and an input terminal; and
wherein the output terminal is adjacent to the connecting terminal and the input terminal is opposite to the connecting terminal, the input terminal and the output terminal both have an opto-electrical conversion unit for converting the optical/electrical signal into an electrical/optical signal, the optical signal transmitted from the optic fiber enters the input terminal and is converted by the opto-electrical conversion unit into the electrical signal, the electrical signal entered via the input terminal is converted by the opto-electrical conversion into the optical signal which is then sent to the optic fiber, and the optical path of the optical signal is installed with a filter and two convergent lenses, the two convergent lenses corresponding to the opto-electrical conversion units for converging the optical signal into the optic fiber and the opto-electrical conversion unit, respectively; and
a circuit board, which is connected to the output terminal and the input terminal for receiving the electrical signal from the output terminal and transmitting the electrical signal to the input terminal;
wherein the filter is installed inside the optical transmitting device at an angle with respect to the optical axis of the optic fiber, so that the optical signal transmitted from the optic fiber is deflected by the filter into the output terminal while the optical signal from the input terminal penetrates the filter to enter the optic fiber.

7. The optical transceiver module of claim 6, wherein the circuit board comprises a plurality of electronic components.

8. The optical transceiver module of claim 6, wherein the circuit board has a plurality of pins.

9. The optical transceiver module of claim 8 further comprising a housing for covering the optical transmitting device and the circuit board, only exposing the optic fiber connecting terminal and the pins to the exterior.

10. A method of arranging the optical path of an optical transceiver module coupled to an optic fiber for transmitting an optical signal using a single optic fiber, the method comprising the steps of:
receiving a first optical signal from the optic fiber;
deflecting the first optical signal into a first opto-electrical conversion unit;
converting the first optical signal into a first electrical signal;
outputting the first electrical signal via an output terminal;
receiving a second electrical signal via an input terminal and sending the second electrical signal to a second opto-electrical conversion unit;
converting the second electrical signal into a second optical signal; and
outputting the second optical signal to the optic fiber.

11. The method of claim 10, wherein the step of deflecting the first optical signal into a first opto-electrical conversion unit is achieved via a filter.

12. The method of claim 10, wherein the output terminal of first electrical signal and the input terminal of second electrical signal are located on two adjacent sides.

13. The method of claim 10, wherein the input terminal of the second electrical signal and the optic fiber connecting terminal are located on two opposite sides.
